(19) United States
(12) Patent Application Publication
(10) Pub. No.: US 2010/0081781 A1
(43) Pub. Date: Apr. 1, 2010

(54) NOVEL POLYETHER ALCOHOLS WHICH BEAR ORGANOSILOXANE GROUPS THROUGH ALKOXYLATION OF EPOXY-FUNCTIONAL (POLY)ORGANOSILOXANES OVER DOUBLE METAL CYANIDE (DMC) CATALYSTS AND PROCESSES FOR PREPARATION THEREOF

(76) Inventors: Frank SCHUBERT, Neukirchen-Vluyn (DE); Wilfried KNOTT, Essen (DE)

Correspondence Address: FROMMER LAWRENCE & HAUG, 745 FIFTH AVENUE- 10TH FL., NEW YORK, NY, 10151, US

(21) Appl. No.: 12/414,805

(22) Filed: Mar. 31, 2009

(30) Foreign Application Priority Data
Apr. 1, 2008 (DE) 10 2008 000903.2

(51) Int. Cl. C08G 77/06; C07F 7/00

(52) U.S. Cl. 528/14; 556/450

(57) ABSTRACT

Novel polyether alcohols (VI) which bear organosiloxane groups by alkoxylation of epoxy-functional (poly)organosiloxanes over double metal cyanide (DMC) catalysts, and process for preparation thereof.

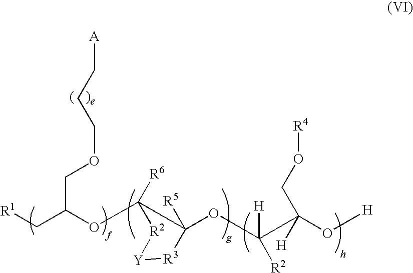

This application claims benefit under 35 U.S.C. 119(a) of German patent application DE 10 2008 000903.2, filed on Apr. 1, 2008.

Any foregoing applications including German patent application DE 10 2008 000903.2, and all documents cited therein or during their prosecution (“application cited documents”) and all documents cited or referenced in the application cited documents, and all documents cited or referenced herein (“herein cited documents”), and all documents cited or referenced in herein cited documents, together with any manufacturer's instructions, descriptions, product specifications, and product sheets for any products mentioned herein or in any document incorporated by reference herein, are hereby incorporated herein by reference, and may be employed in the practice of the invention.

The invention relates to novel polyether alcohols which bear organosiloxane groups through alkoxylation of epoxy-functional (poly)organosiloxanes over DMC catalysts, and to processes for preparation thereof.

Conventional polyether alcohols, often also referred to simply as polyethers for short and predominantly formed from propylene oxide and ethylene oxide, have been known for some time and are produced industrially in large amounts. They serve, inter alia, through reaction with polyisocyanates as starting compounds for preparing polyurethanes or else for preparing surfactants.

Most processes for preparing alkoxylation products (polyethers) make use of basic catalysts, for example the alkali metal hydroxides and the alkali metal methoxides.

Particularly widespread and known for many years is the use of KOH. Typically, a usually low molecular weight hydroxy-functional starter such as butanol, allyl alcohol, propylene glycol or glycerol is reacted in the presence of the alkaline catalyst with an alkylene oxide such as ethylene oxide, propylene oxide, butylene oxide or a mixture of different alkylene oxides to give a polyoxyalkylene polyether. The strongly alkaline reaction conditions in this so-called living polymerization promote various side reactions. Rearrangement of propylene oxide to allyl alcohol, which, in turn, functions as a chain starter, and chain termination reactions form polyethers with a relatively broad molar mass distribution and unsaturated by-products. Especially with allyl alcohol as the starter alcohol, the alkoxylation reaction carried out under alkaline catalysis also gives rise to propenyl polyethers. These propenyl polyethers are found to be unreactive by-products in the hydrosilylating further processing to SiC-supported silicone polyether copolymers and are additionally—as a result of the hydrolytic lability of the vinyl ether bond present therein and release of propionaldehyde—an undesired source of olfactory product nuisances. This is described, for example, in EP-A-1431331 (US 2004-132951).

Another of the disadvantages of base-catalysed alkoxylation is undoubtedly the necessity of freeing the resulting reaction products of the active base with the aid of a neutralization step. In that case, it is absolutely necessary to distillatively remove the water formed in the neutralization and to remove the salt formed by filtration.

As well as the base-catalysed reaction, acid catalyses for alkoxylation are also known. For instance, DE 102004007561 (U.S. 2007-185353) discloses the use of HBF₄ and of Lewis acids, for example BF₃, AlCl₃ and SnCl₄, in alkoxylation technology.

A disadvantage in the acid-catalysed polyether synthesis is found to be the inadequate regioselectivity in the ring-opening of unsymmetrical oxiranes, for example propylene oxide, which leads to the effect that polyoxyalkylene chains with some secondary and some primary OH termini are obtained in a manner which cannot be controlled in an obvious manner. As in the case of the base-catalysed alkoxylation reaction, a workup sequence of neutralization, distillation and filtration is indispensable here too. When ethylene oxide is introduced as a monomer into the acid-catalysed polyether synthesis, the formation of dioxane as an undesired by-product is to be expected.

Acid- and/or base-labile systems, however, can in no way be alkoxylated successively under the conditions detailed. This is particularly true of the organosilicic acid derivatives such as (poly)organosiloxanes, which exhibit a marked tendency to acid- or base-induced hydrolysis and rearrangement of the siloxane skeleton. This is all the more significant in that both the acid- and base-induced alkoxylation reaction typically require a downstream workup in an aqueous medium (neutralization, salt removal, distillation to remove the water).

In the preparation of the economically significant class of the silicone polyethers, use is made, according to the present state of the art and for the lack of a suitable process for direct alkoxylation of organomodified (poly)siloxanes, of a two-stage process regime. A pH-neutral polyether, which has been prepared beforehand by alkoxylating terminally unsaturated alcohols such as allyl alcohol, is added in a subsequent hydrosilylation reaction in the presence of a noble metal catalyst with Si—C bond formation onto a mono- or poly-Si—H-functional (poly)siloxane. Typically, the polyether or the polyether mixture is used in the hydrosilylation in a significant stoichiometric excess of usually 20-35% based on the Si—H functions of the siloxane component, in order to take account of allyl-propenyl rearrangements which are unavoidable in the case of the hydrosilylation of allyl polyethers and to ensure full reaction of all Si—H groups with the double bonds of the polyethers. This means in practice that, in the silicone polyethers prepared according to the present state of the art, relatively large amounts of unreacted and rearranged excess polyethers which lower the concentration of the surfactive silicone polyethers and impair the performance properties of the target products are unavoidably present. The process principle of the hydrosilylation to silicone polyethers which, owing to their interface-active properties, according to the composition, find various uses, for example, as polyurethane foam stabilizers, defoamers, wetting agents or else as dispersing additives, has been described in various embodiments in the patent literature, for example in EP-A1-0585771(U.S. Pat. No. 5,306,737), EP-A1-0600261(U.S. Pat. No. 5,321,051), EP-A1-0867460(U.S. Pat. No. 6,117,963), EP-A1-0867461(U.S. Pat. No. 6,414,175), EP-A1-0867462(U.S. Pat. No. 6,730,749), EP-A1-0867464(U.S. Pat. No. 5,990,187), and EP-A1-0867465(U.S. Pat. No. 5,844,010).

There is to date a lack of a synthesis method which permits silicone polyethers, in many cases also known as polyethersiloxanes, to be prepared in only one simple process step by a direct alkoxylation reaction from epoxy-functional (poly)organosiloxanes. It is therefore an object of the present invention to overcome the deficiencies of the prior art outlined and to provide both novel silicone polyether structures and a novel alkoxylation process for preparing these silicone polyethers. It is a further aim to provide a process which enables silicone polyethers to be prepared with an increased, virtually one-hundred-percent surfactive ingredient content, i.e. without the polyether excess which has been unavoidable to date.

In the context of this invention, the inventive products are referred to, by way of simplification, as silicone polyethers, siloxane-polyether copolymers or polyether-siloxanes and/or the derivatives thereof, even if the process affords substances, as a result of the possible coreactants, with a significantly greater variety of functionality and structural variability. However, what is common to all products is that at least one terminal OH group is formed.

It has now been found that, astonishingly, (poly)organosiloxanes which bear epoxy functions can be alkoxylated in an advantageous and simple manner in the presence of known double metal cyanide catalysts, also known as DMC catalysts, without the tendency to undesired side reactions, such as hydrolysis, condensation or rearrangement reactions, which are characteristic of this substance group, being observed.

The process claimed in accordance with the invention opens up, for the first time and in a very simple and reproducible manner, the possibility of alkoxylating polymerization, proceeding from a starter with reactive hydrogen, of (poly)organosiloxanes which bear epoxy groups to silicone polyethers. The process claimed in accordance with the invention provides the synthetic flexibility of, as well as epoxy-functional (poly)organosiloxanes, incorporating further epoxy compounds such as alkylene oxides and glycidyl compounds, and, if required, further types of monomers, either in terminal positions or in an isolated manner, cumulated in blocks, or else in random distribution, into the polymer chain of a silicone polyether.

The process according to the invention thus enables access to functionalized poly(organo)siloxanes, or polyethersiloxane copolymers which are free of excess polyethers.

The reaction product of the process according to the invention is therefore free of the residues of reactants which have inevitably been present to date, the polyethers (excess polyethers).

The epoxy-functional (poly)organosiloxanes usable in the context of the invention are usually obtained by a hydrosilylation reaction with addition of the appropriate organohydrosiloxanes onto terminally unsaturated epoxy compounds, for example allyl glycidyl ether, and are obtainable on the industrial scale. Any molar allyl glycidyl ether excess used in the process is finally removed by distillation in the preparation process. Functional siloxane compounds obtained in this way are, by virtue of their reactive epoxy groups, valuable synthons and intermediates for various further reactions.

For example, the literature describes the use of organosiloxanes bearing epoxy groups or ring-opening thermally initiated photopolymerization (Yasumasa Morita et. al., J. Appl. Polym. Sci. 2006, 100(3), 2010-2019) by means of hexafluoroantimonate catalysts and cationic photopolymerization (Ricardo Acosta Ortiz et. al., Polymer (2005), 46 (24), 10663-10671). FR-2842098 mentions the use of epoxy-silicone compounds as a constituent of reactive mixtures for cationically initiated and UV-initiated curing of dental cements. Further layers in which different variants of photopolymerization are mentioned are WO-2003076491(U.S. Pat. No. 6,863,701), WO-2002051357 (U.S. Pat. No. 7,129,282) and Sang Yong Pyun et. al., Macromolecular Research (2003), 11(3), 202-205.

Owing to their base and acid sensitivity, epoxy-functional siloxane compounds are entirely unsuitable for a conventional alkali- or acid-catalysed polymerization to give alkoxylation products. It has now been found that, astonishingly, (poly)organosiloxanes which bear epoxy functions can indeed be alkoxylated when the catalysts used are double metal cyanide catalysts, also known as DMC catalysts.

The double metal cyanide catalysts (DMC catalysts) used for the process claimed in accordance with the invention, in terms of their preparation and use as alkoxylation catalysts, have been known since the 1960s and are described, for example, in U.S. Pat. No. 3,427,256, U.S. Pat. No. 3,427,334, U.S. Pat. No. 3,427,335, U.S. Pat. No. 3,278,457, U.S. Pat. No. 3,278,458 or U.S. Pat. No. 3,278,459. Among the ever more effective types of DMC catalysts which have been developed further in the subsequent years and are described, for example, in U.S. Pat. No. 5,470,813 and U.S. Pat. No. 5,482,908 are especially zinc-cobalt hexacyano complexes. By virtue of their exceptionally high activity, for the preparation of polyetherols, only low catalyst concentrations are required, and so the workup stage which is necessary for conventional alkaline catalysts—consisting of neutralization, precipitation and filtering of the catalyst—at the end of the alkoxylation process can be dispensed with. The high selectivity of the DMC-catalysed alkoxylation is attributable to the fact that, for example, propylene oxide-based polyethers contain only very small proportions of unsaturated by-products.

For the DMC-catalysed alkoxylation by the process according to the invention, suitable epoxy compounds are those of the general formula (I)

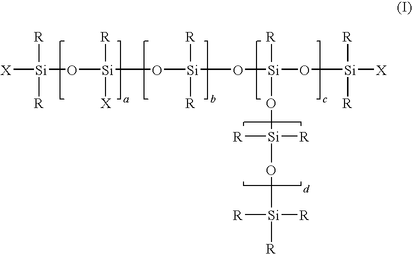

where
R is one or more identical or different radicals selected from linear and branched, saturated, mono- and polyunsaturated alkyl, aryl, alkylaryl or arylalkyl radicals having 1 to 40, especially 1 to 20, carbon atoms and haloalkyl groups having 1 to 20 carbon atoms, and
X is independently either R or a fragment which bears epoxy groups and is of the formula (II)

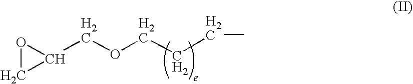

and, independently of one another,
a is an integer of 0 to 5,
b is an integer of 0 to 500,
c is an integer of 0 to 50,
d is an integer of 0 to 200,
e is an integer of 0 to 18,
with the proviso that at least one X radical is an epoxy-functional fragment of the formula (II).

In one embodiment of the invention, e is an integer of 0 to 12. In another embodiment of the invention, e is an integer from 0 to 4. In still another embodiment of the invention e is 1.

The state of the art refers to various alkoxylation processes which make use of catalysis with double metal cyanide catalysts. Reference is made here, for example, to EP-A1-1017738(U.S. Pat. No. 6,077,978), U.S. Pat. No. 5,777,177, EP-A1-0981407(U.S. Pat. No. 5,844,070), WO-2006/002807(US 2007225394) and EP-A-1474464(U.S. Pat. No. 7,312,363).

It has been found that, surprisingly, not just conventional alkylene oxides, such as ethylene oxide, propylene oxide and 1,2-butylene oxide, but also the epoxy-functional organosiloxanes of the formula (I) which are known for their alkali and acid sensitivity, can be alkoxylated in a simple manner in the presence of DMC catalysts. The polymerization of such substituted siloxane compounds proceeds, under the conditions of the DMC catalysis, selectively and sufficiently gently that the process according to the invention opens up the possibility of preparing a new inventive product class of mono- and poly-alkoxysiloxane-modified polyoxyalkylene compounds to obtain a hydrolysis-sensitive organosiloxane structure which tends to rearrange.

A novel process for preparing novel polyethersiloxanes by means of DMC catalysis is thus provided, in which one or more epoxy-functional siloxane monomers of the formula (I), individually or in a mixture with further epoxy compounds of the formula (III) or (IV), are added either blockwise or randomly onto a chain starter of the formula (V) with at least one reactive hydrogen. The organosiloxane monomers bearing at least one epoxy group may be distributed randomly in the polymer chain or may be arranged in chain terminal positions in the polymer skeleton.

It is a further aim of the process according to the invention to obtain the advantages, which are known from the double metal cyanide systems, of a high reaction rate and of dispensing with the catalyst deactivation and removal.

Furthermore, it is an aim of the process according to the invention to preserve the organosiloxane structure under the reaction conditions of the selective DMC-catalysed alkoxylation and hence to create access to a new, likewise inventive class of silicone polyethers which, in contrast to polyethersiloxanes prepared conventionally by the route of hydrosilylation, do not contain any unconverted residues of polyethers, but rather consist virtually exclusively of the surfactive and desired target product.

It is noted that in this disclosure and particularly in the claims and/or paragraphs, terms such as “comprises”, “comprised”, “comprising” and the like can have the meaning attributed to it in U.S. patent law; e.g., they can mean “includes”, “included”, “including”, and the like; and that terms such as “consisting essentially of” and “consists essentially of” have the meaning ascribed to them in U.S. patent law, e.g., they allow for elements not explicitly recited, but exclude elements that are found in the prior art or that affect a basic or novel characteristic of the invention.

It is further noted that the invention does not intend to encompass within the scope of the invention any previously disclosed product, process of making the product or method of using the product, which meets the written description and enablement requirements of the USPTO (35 U.S.C. 112, first paragraph) or the EPO (Article 83 of the EPC), such that applicant(s) reserve the right and hereby disclose a disclaimer of any previously described product, method of making the product or process of using the product.

All molecular masses are average values over a broad range of molecular mass distribution and are measured by gel permeation chromatography (GPC).

The silicone compounds used in accordance with the invention as epoxy-functional (poly)organosiloxanes are compounds of the general formula (I)

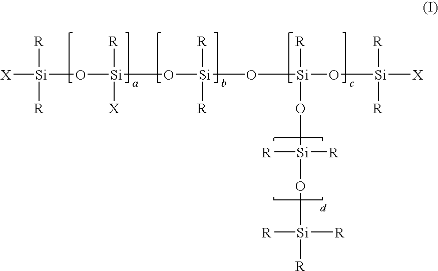

where
R is one or more identical or different radicals selected from linear and branched, saturated, mono- and polyunsaturated alkyl, aryl, alkylaryl or arylalkyl radicals having 1 to 40, especially 1 to 20, carbon atoms and haloalkyl groups having 1 to 20 carbon atoms,
   and
X is independently either R or a fragment which bears epoxy groups and is of the formula (II)

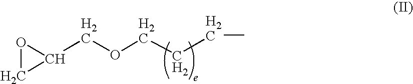

and, independently of one another,
a is an integer of 0 to 5,
b is an integer of 0 to 500,
c is an integer of 0 to 50,
d is an integer of 0 to 200,
e is an integer of 0 to 18,
with the proviso that at least one X radical is an epoxy-functional fragment of the formula (II). The structural elements indicated by the indices a, b and c in the siloxane structure are freely permutable and may be present either in random distribution or in blocks.

In one embodiment of the invention, e is an integer of 0 to 12. In another embodiment of the invention, e is an integer from 0 to 4. In still another embodiment of the invention e is 1.

An unexclusive list of such epoxy-substituted siloxanes of the formula (I), which can be used alone or in mixtures with one another or in combination with epoxy compounds of the formulae (III) and (IV), comprises, for example, α,ω-di(glycidyloxypropyl)poly(dimethylsiloxane), 3-glycidyloxypropy1-1,1,1,3,5,5,5-heptamethyltrisiloxane, 5-glycidyloxypropy1-1,1,1,3,3,5,5-heptamethyltrisiloxane, hydrosilylation products of allyl glycidyl ether with copolymers from the equilibration of poly(methylhydro-siloxane) with siloxane cycles and hexamethyldisiloxane, and hydrosilylation products of allyl glycidyl ether with copolymers from the equilibration of poly(methylhydro-siloxane) with siloxane cycles and α,ω-dihydropoly-dimethylsiloxane.

The epoxy-functional siloxanes of the formula (I) can be used in the DMC-catalysed alkoxylation to prepare silicone polyethers by the process according to the invention, if required, in any desired sequence of metered addition, in succession or in a mixture with alkylene oxides of the general formula (III)

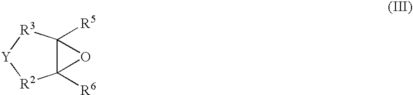

where R² or R³, and R⁵ or R⁶, are identically or else independently H or a saturated or optionally mono- or polyunsaturated, optionally mono- or polyvalent hydrocarbon radical which may also have further substitution, where the R⁵ or R⁶ radicals are each a monovalent hydrocarbon radical. The hydrocarbon radical may be bridged cycloaliphatically via the Y fragment; Y may be absent, or else may be a methylene bridge with 1 or 2 methylene units; when Y is O, R² and R³ are each independently a linear or branched radical having 1 to 20, preferably 1 to 10, carbon atoms, more preferably a methyl, ethyl, propyl or butyl, vinyl, allyl radical or phenyl radical. Preferably at least one of the two R² and R³ radicals in formula (III) is hydrogen. Particularly preferred alkylene oxides are ethylene oxide, propylene oxide, 1,2- or 2,3-butylene oxide, isobutylene oxide, 1,2-dodecene oxide, styrene oxide, cyclohexene oxide (R²-R³ here is a —CH₂CH₂CH₂CH₂— group, and Y is thus —CH₂CH₂—) or vinylcyclohexene oxide or mixtures thereof. The hydrocarbon radicals R² and R³ of the formula (III) may in turn have further substitution and bear functional groups such as halogens, hydroxyl groups or glycidyloxy-propyl groups. Such alkylene oxides include epichlorohydrin and 2,3-epoxy-1-propanol.

It is likewise possible to use glycidyl compounds such as glycidyl ethers and/or glycidyl esters of the general formula (IV)

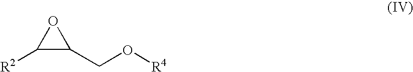

where R² is as defined for formula (III) and in which at least one glycidyloxypropyl group is bonded via an ether or ester function R⁴ to a linear or branched alkyl radical of 1 to 24 carbon atoms, an aromatic or cycloaliphatic radical, in combination with the epoxy-functional siloxanes described in formula (I) and optionally in addition to the alkylene oxides of the formula (III). This class of compounds includes, for example, allyl glycidyl ether, butyl glycidyl ether, 2-ethylhexyl glycidyl ether, cyclohexyl glycidyl ether, benzyl glycidyl ether, C₁₂/C₁₄-fatty alcohol glycidyl ether, phenyl glycidyl ether, p-tert-butylphenyl glycidyl ether or o-cresyl glycidyl ether. Glycidyl esters used with preference are, for example, glycidyl methacrylate, glycidyl acrylate or glycidyl neodecanoate. It is likewise possible to use polyfunctional epoxy compounds, for example 1,2-ethyl diglycidyl ether, 1,4-butyl diglycidyl ether or 1,6-hexyl diglycidyl ether.

The starters or starter compounds used for the alkoxylation reaction may be all compounds of the formula (V)

R¹—H (V)

(the H belongs to the OH group of an alcohol or of a phenolic compound), alone or in mixtures with one another, which, according to the formula (V), have at least one reactive hydroxyl group. R¹ corresponds to a saturated or unsaturated, optionally branched radical, or is a polyether radical of the alkoxy, arylalkoxy or alkylarylalkoxy group type, in which the carbon chain may be interrupted by oxygen atoms, or R¹ is a singly or multiply fused aromatic group to which a phenolic OH group is bonded directly. The chain length of the polyether radicals which have alkoxy, arylalkoxy or alkylarylalkoxy groups and can be used as starter compound is as desired. The polyether, alkoxy, arylalkoxy or alkylarylalkoxy group preferably contains 1 to 1500 carbon atoms, more preferably 2 to 300 carbon atoms, especially 2 to 100 carbon atoms.

Starter compounds are understood in the context of the present invention to mean substances which form the start of the polyether molecule to be prepared, which is obtained by the inventive addition of epoxy-functional monomers of the formulae (I), (III) and (IV). The starter compound used in the process according to the invention is preferably selected from the group of the alcohols, polyetherols or phenols. Preference is given to using, as the starter compound, a mono- or polyhydric polyether alcohol or alcohol R¹—H (the H belongs to the OH group of the alcohol or phenol). The starter compounds can be used alone or else in a mixture with one another.

The OH functional starter compounds R¹—H (V) used are preferably hydrocarbon compounds whose carbon skeleton may be interrupted by oxygen atoms, and which have molar masses of from 18 to 10 000 g/mol, especially 50 to 2000 g/mol, and have 1 to 8, preferably 1 to 4, hydroxyl groups.

Examples of compounds of the formula (V) include allyl alcohol, butanol, octanol, dodecanol, stearyl alcohol, 2-ethylhexanol, cyclohexanol, benzyl alcohol, ethylene glycol, propylene glycol, di-, tri- and polyethylene glycol, 1,2-propylene glycol, di- and polypropylene glycol, 1,4-butanediol, 1,6-hexanediol, trimethylol-propane, glycerol, pentaerythritol, sorbitol, cellulose sugar, lignin or else further compounds which bear hydroxyl groups and are based on natural substances.

Advantageously, low molecular weight polyetherols having 1-8 hydroxyl groups and molar masses of 50 to 2000 g/mol, which in turn have been prepared beforehand by DMC-catalysed alkoxylation, are used as starter compounds.

In addition to compounds with aliphatic and cycloaliphatic OH groups, suitable compounds are any compounds having 1-20 phenolic OH functions. These include, for example, phenol, alkyl- and arylphenols, bisphenol A and novolacs.

To start the alkoxylation reaction in the process according to the invention, the starter mixture consisting of a starter or a plurality of OH-functional starter compounds of the formula (V) and the double metal cyanide catalyst, which has optionally been slurried beforehand in a suspension medium, is initially charged in the reactor. The suspension medium used may either be a polyether or inert solvents, or else advantageously one or more starter compounds of the formula (V), or alter-natively a mixture of the two components. At least one of the epoxy compounds of the formula (I), (III) or (IV) is metered into the initially charged starter mixture. To start the alkoxylation reaction and to activate the double metal cyanide catalyst, at first usually only a portion of the total amount of epoxide to be metered in is added. For this purpose, preference is given to using an alkylene oxide of the formula (III), very particular preference to using propylene oxide or 1,2-butylene oxide. The molar ratio of epoxide to the reactive groups of the starter, especially the OH groups in the starter mixture, in the start phase is preferably 0.1 to 10:1, preferentially 0.2 to 5:1, especially 0.4 to 3:1. It may be advantageous when, before the addition of the epoxide, any reaction-inhibiting substances present are removed from the reaction mixture, for example by distillation.

The start of the exothermic reaction can be detected, for example, by monitoring the pressure and/or temperature. A sudden drop in the pressure in the reactor indicates, in the case of gaseous alkylene oxides, that the alkylene oxide is being incorporated, the reaction has thus started and the end of the start phase has been attained.

After the start phase, i.e. after initialization of the reaction, according to the molar mass desired, either further starter compound of the formula (V) and further epoxide are metered in simultaneously or only further epoxide is metered in. The different epoxides of the formulae (I), (III) and (IV) can be added on either individually or in any desired mixture. Preference is given to copolymerizing the epoxy-functional siloxane monomers used in accordance with the invention in combination with alkylene oxides. For example, for the purpose of lowering the viscosity of the reaction mixture, the reaction can be carried out in an inert solvent. Suitable inert solvents are hydrocarbons, especially toluene, xylene or cyclohexane.

In the inventive products, the molar ratio of the sum of the epoxides metered in, including the epoxides already added in the start phase, based on the starter compound used, more particularly based on the number of OH groups in the starter compound used, is preferably 1 to 10⁵:1, especially 1 to 10⁴:1.

The addition of the epoxy compounds proceeds preferably at a temperature of 60 to 250° C., more preferably at a temperature of 90 to 160° C. The pressure at which the alkoxylation takes place is preferably 0.02 bar to 100 bar, more preferably 0.05 to 20 bar and especially 0.2 to 5 bar absolute. The performance of the alkoxylation under reduced pressure allows the reaction to be performed very reliably. If appropriate, the alkoxylation can be carried out in the presence of an inert gas (for example nitrogen).

After the monomer addition and any postreaction to complete the monomer conversion, any residues present of unreacted monomer and any further volatile constituents are removed, typically by vacuum distillation, gas stripping or other methods of deodorization. Volatile secondary components can be removed either batchwise or continuously. In the process according to the invention based on DMC catalysis, it is normally possible to avoid a filtration.

The process steps can be carried out at identical or different temperatures. The mixture of starter substance, DMC catalyst and optionally suspension medium initially charged in the reactor at the start of the reaction can, before the start of the metered addition of monomers, be pretreated by stripping according to the teaching of WO-98/52689 (U.S. Pat. No. 5,844,070). In this case, an inert gas is added to the reaction mixture via the reactor feed and relatively volatile components are removed from the reaction mixture by applying a reduced pressure with the aid of a vacuum system attached to the reactor system. In this simple manner, it is possible to remove from the reaction mixture substances which can inhibit the catalyst, for example lower alcohols or water. The addition of inert gas and the simultaneous removal of the relatively volatile components may be advantageous especially in the startup of the reaction since, as a result of the addition of the reactants or as a result of side reactions, inhibiting compounds can also get into the reaction mixture.

The DMC catalysts used may be all known DMC catalysts, preferably those which comprise zinc and cobalt, preferentially those which comprise zinc hexacyanocobaltate (III). Preference is given to using the DMC catalysts described in U.S. Pat. No. 5,158,922, US 20030119663, WO 01/80994 (U.S. 2003-158449) or in the above-mentioned documents. The catalysts may be amorphous or crystalline.

In the reaction mixture, the catalyst concentration is preferably >(greater than) 0 to 2000 ppmw (ppm by mass), preferably >0 to 1000 ppmw, more preferably 0.1 to 500 ppmw and most preferably 1 to 200 ppmw. This concentration is based on the total mass of alkoxylation products formed.

Preference is given to metering the catalyst only once into the reactor. The amount of catalyst should be set so as to give rise to a sufficient catalytic activity for the process. The catalyst may be metered in in solid form or in the form of a catalyst suspension. When a suspension is used, a suitable suspension medium is especially the starter of the formula (V). However, preference is given to avoid a suspension.

The process according to the invention equally provides inventive polyethersiloxanes of the formula (VI) which are notable in that they can be prepared in a controlled manner and reproducibly with regard to structure and molar mass.

More particularly, the process according to the invention thus enables access to functionalized poly(organo)-siloxanes, or polyethersiloxane copolymers, which are free of excess polyethers.

The reaction product of the process according to the invention is therefore free of the residues of reactants whose presence has been inevitable to date, the polyethers (excess polyethers). The sequence of the monomer units can be configured variably within wide limits. Epoxy monomers of the (I), (III) and (IV) type may be incorporated into the polymer chain in any blockwise sequence or randomly. The fragments inserted into the polymer chain as it forms by the reaction with ring-opening of the reaction components of the formulae (I), (III) and (IV) are freely permutable with one another in their sequence.

When X in formula (I) corresponds to the epoxy fragment (II) in more than one case, the process according to the invention forms polyethersiloxanes in the form of highly functionalized networks in which polymer chains which are each started from the starter compound R¹—H (V) and which contain the fragments which are freely permutable not only with respect to their sequence, which have been inserted into the polymer chain as it forms by the reaction with ring-opening of the reaction components of the formulae (I), (III) and (IV), are joined to one another via the structural units defined by the siloxane skeleton of the formula (I).

There thus form highly complex, highly functionalized, high molecular weight structures. The functionalities can be adjusted in a controlled manner to a desired field of use. The alkoxylation of mixtures of mono-, di- or poly-epoxy-functional organosiloxanes of the formula (I) allows the epoxy functionality to be adjusted. The degree of crosslinking and the complexity of the resulting polymer structures rise with increasing mean number of epoxy groups in the monomer or monomer mixture. Preference is given to an epoxy functionality between 1 and 2, very particular preference to an epoxy functionality of 1 to 1.5.

The fragments which have been inserted into the polymer chain as its forms by the reaction with ring-opening of the reaction components of the formulae (I), (III) and (IV), in the context of the preceding definitions, may occur in blockwise or random distribution, not just in the chain of a polyether structural unit, but also in random distribution over the multitude of polyether structural units which have been formed and are bonded to one another via the siloxane structural units defined by formula (I).

The manifold nature of the structural variations of the process products thus does not permit any clear description by means of a formula. Preference is given to the inventive polyether structures of the formula (VI) which arise through the inventive alkoxylation of mono-epoxy-functional organosiloxanes of the formula (I), in which the X radical corresponds to the fragment (II) only in one case and is otherwise equivalent to the R radical

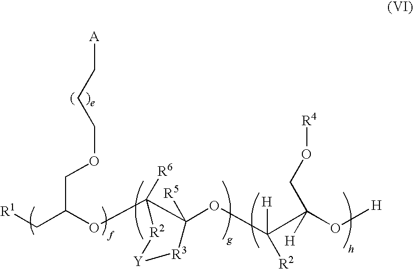

where the fragment A corresponds to the structural element of the formula (VIa)

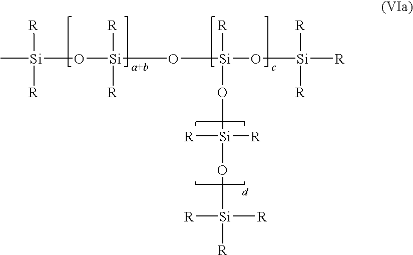

or to the structural element of the formula (VIb)

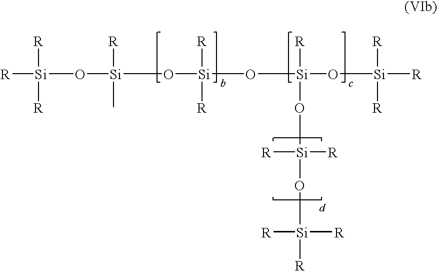

and a in formula (I) simultaneously assumes the value of 1.

The substituents R, R¹-R⁶, the A, X and Y radicals and the indices a, b, c, d and e each correspond to the definitions given above for the compounds of the formulae (I) to (V), where
f is an integer of 1 to 200, preferably 1 to 100, more preferably 1 to 20 and especially 1 to 10,
g is an integer of 0 to 10 000, preferably 0 to 1000, more preferably 0 to 300 and especially 0 to 100,
h is an integer of 0 to 1000, preferably 0 to 100, more preferably 0 to 50 and especially 0 to 30,
   with the proviso that the fragments with the indices f, g and h are freely permutable with one another, i.e. are exchangeable for one another in the sequence within the polyether chain.

The different monomer units with the indices f, g and h may be in alternating blockwise structure or else be subject to a random distribution.

The indices and the value ranges of the indices specified which are represented in the formulae adduced here should therefore be understood as the mean values of the possible random distribution of the structures actually present and/or mixtures thereof. This is also true for structural formulae specified in exact terms per se, for example for formula (VI).

Preference is given to compounds prepared by the process according to the invention which contain the fragments which form through the reaction with ring-opening of the reaction components of the formulae (I) and (III), and in which the fragment with the index g is present in a molar excess with respect to the fragment with the index f. The ratio of g to f is preferably 2 to 500:1, more preferably 5 to 300:1, most preferably 5 to 100:1. The index h may assume any values from 0 to 1000.

These inventive silicone polyether/polyethersiloxanes, or else polyethersiloxane copolymers, owing to their different kind of chemical structure compared with compounds synthesized in a conventional manner via the hydrosilylation route, constitute a new product class. The process according to the invention permits the polymer structure of the inventive siloxane-polyether copolymers, according to the type of starter and type, amount and sequence of the epoxy monomers usable, to be varied in many ways and thus product properties important from a performance point of view to be tailored as a function of the end use. The interface-active properties of the products, generally their hydrophilicity or hydrophobicity, can be influenced within wide limits by structural variations. Their performance properties, in contrast to polyethersiloxanes currently available, are not impaired by proportions of free polyethers. The novel silicone polyethers are instead concentrates of surfactive compounds. The polymers obtained by processes according to the invention are therefore suitable, for example, as polyurethane foam stabilizers, wetting agents, dispersing additives, devolatilizers or defoamers.

In the case that f is zero, the formula (VI) corresponds to a polyether unsubstituted by the siloxane functionalization. Such a polyether corresponds simultaneously to the secondary component in processes known to date in the form of the incompletely reacting reactant and hence to the excess polyether remaining in the product.

The reactors used for the reaction claimed in accordance with the invention may in principle be all suitable reactor types which allow the reaction and any exothermicity present therein to be controlled.

In the manner known in process technology, the reaction can be effected continuously, semicontinuously or else batchwise, and can be adjusted flexibly to the production technology equipment available.

As well as conventional stirred tank reactors, it is also possible to use jet loop reactors with gas phase and internal heat exchange tubes, as described in WO01/062826. In addition, gas phase-free loop reactors can be used.

In the metered addition of the reactants, a good distribution of substances involved in the reaction, i.e. of the epoxy monomers, starter, DMC catalyst and if appropriate suspension medium, should be ensured.

A further subject matter of the invention is described by the claims.

The inventive polyethers and the corresponding processes for preparing them are described by way of example hereinafter, without any possibility that the invention can be regarded as restricted to these illustrative embodiments.

The ranges, general formulae or compound classes specified below shall encompass not just the corresponding ranges or groups of compounds which are mentioned explicitly but also all sub-ranges and sub-groups of compounds which can be obtained by selecting individual values (ranges) or compounds.

### WORKING EXAMPLES

In the examples adduced below, the present invention is described by way of example, without any possibility that the invention, whose scope of application is evident from the entire description and the claims, can be interpreted as restricted to the embodiments specified in the examples.

Preparation of polyether alcohols bearing siloxane groups by the process according to the invention with the aid of DMC catalysts. The mean molar masses were determined by GPC analysis against polypropylene glycol as the standard. The epoxy-functional siloxane used as the monomer in the experiments described hereinafter was prepared in accordance with the known prior art by Pt-catalysed hydrosilylation of heptamethyltrisiloxane with allyl glycidyl ether.

### Example 1

A 3 litre autoclave is initially charged with 200.0 g of polypropylene glycol monobutyl ether (mean molar mass 750 g/mol) and 0.017 g of zinc hexacyanocobaltate DMC catalyst under nitrogen, and heated to 130° C. with stirring. The reactor is evacuated down to an internal pressure of 30 mbar in order to remove any volatile ingredients present by distillation. To activate the DMC catalyst, a portion of 50.0 g of propylene oxide is supplied. After 20 min and startup of the reaction (decline in internal reactor pressure), 100.0 g of epoxysiloxane based on heptamethyltrisiloxane and allyl glycidyl ether and 368.0 g of propylene oxide, continuously and with cooling within 30 min, are simultaneously metered in at 130° C. and internal reactor pressure max. 1.2 bar absolute. The 180-minute postreaction at 130-150° C. is followed by the degassing stage. In this stage, volatile fractions such as residual propylene oxide are distilled off under reduced pressure.

The finished colourless, low-viscosity and clear polyethersiloxane is cooled to below 80° C. and discharged from the reactor.

The product has a mean molar mass M_{w} of 4300 g/mol and Mₙ of 2500 g/mol.

### Example 2

A 3 litre autoclave is initially charged with 200.0 g of polypropylene glycol monobutyl ether (mean molar mass 750 g/mol) and 0.015 g of zinc hexacyanocobaltate DMC catalyst under nitrogen, and heated to 130° C. with stirring. The reactor is evacuated down to an internal pressure of 30 mbar in order to remove any volatile ingredients present by distillation. To activate the DMC catalyst, a portion of 50.0 g of propylene oxide is supplied. After 20 min and startup of the reaction (decline in internal reactor pressure), a homogeneous mixture of 100.0 g of epoxysiloxane based on heptamethyl-trisiloxane and allyl glycidyl ether and 463.0 g of 1,2-butylene oxide, continuously and with cooling within 35 min, is metered in at 135° C. and internal reactor pressure max. 0.8 bar absolute. The 180-minute postreaction at 135-150° C. is followed by the degassing stage. In this stage, volatile fractions such as residual 1,2-butylene oxide are distilled off under reduced pressure. The finished colourless, low-viscosity polyethersiloxane is cooled to below 80° C. and discharged from the reactor.

The product has a mean molar mass M_{w} of 3000 g/mol and Mₙ of 2000 g/mol.

### Example 3

A 3 litre autoclave is initially charged with 200.0 g of polypropylene glycol monobutyl ether (mean molar mass 2200 g/mol) and 0.015 g of zinc hexacyanocobaltate DMC catalyst under nitrogen, and heated to 130° C. with stirring. The reactor is evacuated down to an internal pressure of 30 mbar in order to remove any volatile ingredients present by distillation. To activate the DMC catalyst, a portion of 58.0 g of propylene oxide is supplied. After 15 min and startup of the reaction (decline in internal reactor pressure), 6 portions each of 16.0 g of epoxysiloxane, based on heptamethyltri-siloxane and allyl glycidyl ether, and 26.0 g of propylene oxide, with cooling within 5 hours, are metered in in alternation at 125° C. and internal reactor pressure max. 1.0 bar absolute. The 150-minute postreaction at 125-150° C. is followed by the degassing stage to distil off volatile fractions such as residual propylene oxide under reduced pressure. The finished polyethersiloxane is cooled to below 90° C. and discharged from the reactor.

The colourless, medium-viscosity product of blockwise structure is turbid and has a mean molar mass M_{w} of 11 200 g/mol and Mₙ of 3600 g/mol.

### Example 4

A 3 litre autoclave is initially charged with 200.0 g of polypropylene glycol monobutyl ether (mean molar mass 2200 g/mol) and 0.017 g of zinc hexacyanocobaltate DMC catalyst under nitrogen, and heated to 130° C. with stirring. The reactor is evacuated down to an internal pressure of 30 mbar in order to remove any volatile ingredients present by distillation. To activate the DMC catalyst, a portion of 50.0 g of propylene oxide is supplied. After 10 min and startup of the reaction (decline in internal reactor pressure), a homogeneous mixture of 200.0 g of epoxysiloxane based on heptamethyl-trisiloxane and allyl glycidyl ether and 463.0 g of 1,2-butylene oxide, with cooling within 70 min, are metered in at 125° C. and internal reactor pressure max. 0.8 bar absolute. After 150 min of postreaction at 125-150° C., 78.0 g of propylene oxide are added within 5 min at 130° C. and internal reactor pressure max. 1.5 bar. There follows another postreaction of 150 min at 130-150° C. and the degassing stage to distil off volatile fractions such as residual epoxide under reduced pressure. The finished polyethersiloxane is cooled to below 90° C. and discharged from the reactor.

The colourless and low-viscosity product of mixed structure has a mean molar mass M_{w} of 4000 g/mol and Mₙ of 2900 g/mol.

Having thus described in detail various embodiments of the present invention, it is to be understood that the invention defined by the above paragraphs is not to be limited to particular details set forth in the above description as many apparent variations thereof are possible without departing from the spirit or scope of the present invention.

1. A process for preparing silicone polyethers by alkoxylating (poly)organosiloxanes which bear epoxy groups in the presence of double metal cyanide catalysts.

2. The process of claim 1 wherein the starting material is R¹—H (V) with reactive hydrogen.
[Process for preparing silicone polyethers according to claim 1 by alkoxylating polymerization of (poly)organosiloxanes which bear epoxy groups proceeding from a starter R¹—H (V) with reactive hydrogen by means of DMC catalysts.]

3. The process according to claim 1, characterized in that the monomers are distributed in a terminal or isolated manner or cumulated in blocks or distributed randomly in the polymer chain of the silicone polyether.

4. The process according to claim 1, characterized in that the epoxy-functional (poly)organosiloxanes used are compounds of the general formula (I) 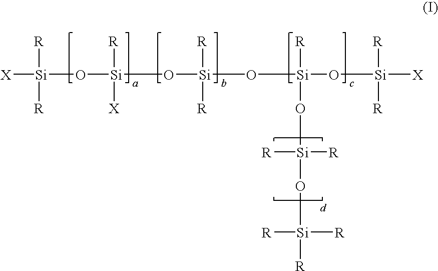
where
R is one or more identical or different radicals selected from linear and branched, saturated, mono- and polyunsaturated alkyl, aryl, alkylaryl or arylalkyl radicals having 1 to 40 carbon atoms and haloalkyl groups having 1 to 20 carbon atoms, and
X is independently either R or a fragment which bears epoxy groups and is of the formula (II) 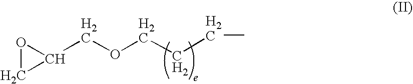
and, independently of one another,
a is an integer of 0 to 5,
b is an integer of 0 to 500,
c is an integer of 0 to 50,
d is an integer of 0 to 200,
e is an integer of 0 to 18, and
the structural elements indicated by the indices a, b and c in the siloxane structure are freely permutable and may be present either in random distribution or in blocks,
with the proviso that at least one X radical is an epoxy-functional fragment of the formula (II).

5. The process according to claim 1, characterized in that one or more epoxy-functional siloxane monomers of the formula (I), individually or in a mixture with further epoxy compounds of the formula (III) 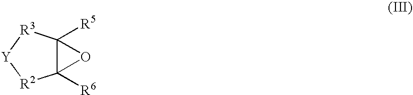
where
R² or R³, and R⁵ or R⁶, are identically or else independently H or a saturated or optionally mono- or polyunsaturated, optionally mono- or polyvalent hydrocarbon radical which may also have further substitution, where the R⁵ or R⁶ radicals are each a monovalent hydrocarbon radical, where the hydrocarbon radical may be bridged cycloaliphatically via the Y fragment; Y may be absent, or else may be a methylene bridge with 1 or 2 methylene units; when Y is O, R² and R³ are each independently a linear or branched radical having 1 to 20 carbon atoms, and the hydrocarbon radicals R² and R³ may in turn have further substitution and bear functional groups such as halogens, hydroxyl groups or glycidyloxy-propyl groups,
or (IV) 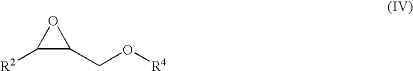
in R² is as defined above and in which at least one glycidyloxypropyl group is bonded via an ether or ester function R⁴ to a linear or branched alkyl radical of 1 to 24 carbon atoms, an aromatic or cycloaliphatic radical,
are added either blockwise or randomly onto a chain starter of the formula (V) with at least one reactive hydrogen and the organosiloxane monomers which bear at least one epoxy group may either be scattered randomly in the polymer chain or be arranged in chain terminal positions in the polymer skeleton.

6. The process according to claim 1, characterized in that the starters R¹—H (V) used are hydrocarbon compounds whose carbon chain may be interrupted by oxygen atoms and which have molar masses of 18 to 10 000 g/mol, especially 50 to 2000 g/mol, and have 1 to 8 aliphatic, cycloaliphatic or phenolic hydroxyl groups.

7. The process according to claim 6, characterized in that allyl alcohol, butanol, octanol, dodecanol, stearyl alcohol, 2-ethylhexanol, cyclohexanol, benzyl alcohol, ethylene glycol, propylene glycol, di-, tri- and polyethylene glycol, 1,2-propylene glycol, di- and polypropylene glycol, low molecular weight polyetherols having 1-8 hydroxyl groups and molar masses of 50 to 2000 g/mol, 1,4-butanediol, 1,6-hexanediol, trimethylolpropane, glycerol, penta-erythritol, sorbitol, cellulose sugar, lignin, phenol, alkyl- and arylphenols, bisphenol A and novolacs, or else further compounds which bear hydroxyl groups and are based on natural substances, alone or in a mixture with one another, are used as starters R¹—H (V).

8. The process according to claim 1, characterized in that the reaction is carried out in one inert solvent or in mixtures of a plurality of inert solvents.

9. The process according to claim 1, characterized in that the solvent or suspension medium used for the DMC catalyst is the starter R¹—H (V).

10. The process according to claim 1, characterized in that the molar ratio of the sum of the epoxides metered in, including the epoxides already added in the start phase, based on the starter compound used, more particularly based on the number of OH groups of the starter compound used, is 1 to 10⁵:1.

11. The process according to claim 1, characterized in that the reaction is effected batchwise or continuously.

12. The process according to claim 1, characterized in that the DMC catalyst concentration is greater than 0 to 2000 ppmw based on the total mass of the alkoxylation products formed.

13. The process according to claim 12, characterized in that the catalyst is metered in in solid form or in the form of a catalyst suspension.

14. A polyethersiloxane prepared by a process according to claim 1.

15. The polyethersiloxane of claim 14 wherein the polyethersiloxane is of the formula (VI) 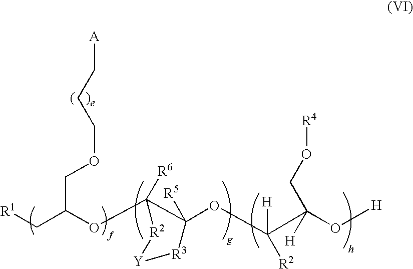
where the fragment A corresponds to the structural element of the formula (VIa) 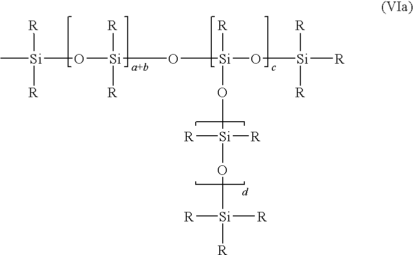
or to the structural element of the formula (VIb) 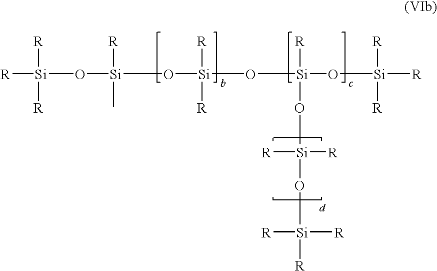
where, in formula (VIb), the A of the original fragment of the formula (I) assumes the value of 1 and the substituents R, R¹-R⁶, the A, X and Y radicals and the indices a, b, c, d and e each correspond to the definitions given above for the compounds of the formulae (I) to (V),
f is an integer of 1 to 200,
g is an integer of 0 to 10 000,
h is an integer of 0 to 1000,
with the proviso that the fragments with the indices f, g and h are freely permutable with one another and hence are exchangeable for one another in the sequence within the polyether chain and the different monomer units with the indices f, g and h are in an alternating blockwise structure or else may be subject to a random distribution.

16. The polyethersiloxane of claim 15 in which the fragment with the index g is present in a molar excess with respect to the fragment with the index f.

17. The polyethersiloxane of claim 15 which are free of excess polyethers.

18. The polyethersiloxane of claim 15 which are free of compounds of the formula (VI) where f is zero.
